(19) United States
(12) Patent Application Publication
(10) Pub. No.: US 2020/0197254 A1
(43) Pub. Date: Jun. 25, 2020

(54) Pick-Up Aid on a Shaft-Like Object

(71) Applicant: DEHLERINNOVATION UG, Pressing (DE)

(72) Inventor: Nils Dehler, Pressig (DE)

(21) Appl. No.: 16/625,680

(22) PCT Filed: Jun. 29, 2018
(86) PCT No.: PCT/EP2018/067640

§ 371 Date: Mar. 10, 2020

(30) Foreign Application Priority Data
Jul. 4, 2017 (DE) 10 2017 114 850.7

(51) Int. Cl. A61H 3/02; A45B 3/00

(52) U.S. Cl. CPC A61H 3/02; A61H 2003/0222; A45B 3/00

(57) ABSTRACT

A pick-up aid on a shaft-like object which can be a crutch or a tool. The pick-up aid is mounted on a shaft of the crutch or on a handle of the tool so as to be pivotable about a bearing axis and to extend along the shaft or handle and comprises an auxiliary grip part with a disc head and a finger arm. The shaft-like object has a preferred direction of falling over, and the pick-up aid is mounted to the shaft-like object such that when it falls over, the disc head will hit the ground and the finger arm will thereby be erected relative to the shaft or handle.

### FIELD OF THE INVENTION

The invention relates to a pick-up aid on a shaft-like object which can be a crutch or a tool. Crutches are known in the form of a forearm crutch or an armpit crutch. Tools in the form of a shaft-like object may be brooms, floor cleaning mops, or similar household tools, or else garden tools, such as a street broom, rake, or shovel. A pick-up aid may be desirable for such shaft-like objects.

Persons who need a walking aid or crutch usually have difficulty bending down and picking up objects from the ground. This also applies to the walking aid or crutch itself if it has fallen on the ground.

DE 43 16 284 C2 discloses a pick-up device for a walking aid, which comprises an additional casing with two intermeshing gearwheels mounted therein, of which the first gearwheel is a triggering slide in the form of a toothed bar and the second gearwheel has a grip arm attached thereto. When the crutch falls on the triggering slide, the first gear is rotated and drives the second gear, which pivots the grip arm away from the longitudinal extent of the walking aid, making the grip arm easier to grasp. This pick-up device has a complicated structure and is very complex in manufacture.

### GENERAL DESCRIPTION OF THE INVENTION

An object of the invention is to provide a pick-up aid on a shaft-like object, which is simple in configuration and can be manufactured with little effort. In particular it is intended to provide a pick-up aid which makes it easier even for a disabled person to grip and lift a crutch lying on the ground.

The object of the invention is achieved by the subject matter of the independent claims. Advantageous embodiments of the invention are specified in the dependent claims.

To achieve the stated goal, the shaft-like object which can be a crutch or a tool is provided with a pick-up aid which comprises an auxiliary grip part which is erected when the shaft-like object falls over and enables the person to grip the fallen shaft-like object and lift it. For this purpose, the auxiliary grip part is pivotable about a bearing axis that is oriented transversely, i.e. in particular perpendicular or substantially perpendicular to the shaft or handle of the shaft-like object. If the shaft-like object falls over and the auxiliary grip part hits the ground, a finger arm will erect and can be used to lift the fallen object.

More particularly, the auxiliary grip part has a disc head and a finger arm integrally connected thereto. The bearing axis is aligned transversely to the shaft-like object and enables the auxiliary grip part to pivot relative to the shaft-like object. For this purpose, the bearing axis must be coupled to the shaft-like object, or if the bearing axis is firmly connected to the auxiliary grip part, the shaft-like object must have a bearing for the bearing axis of the auxiliary grip part. There are various ways of mounting the pick-up aid to the shaft-like object.

In the present application, a walking aid or crutch is considered to be a shaft-like object and has a shaft with a grip attached thereto. In a preferred embodiment, the auxiliary grip part is pivotally mounted to the shaft of the crutch by means of a fastening clamp which for this purpose supports the bearing axis of the auxiliary grip part. The shaft and the grip of the crutch span a plane, and the bearing axis preferably extends in this plane approximately parallel to the grip of the crutch and perpendicularly projecting from the shaft. The disc head extends in a disc plane to which the bearing axis defines a perpendicular. When the crutch hits the ground, the disc head receives an eccentric impact, i.e. the impact direction is offset from the bearing axis, and as a result thereof a torque is produced acting on the auxiliary grip part about the bearing axis. The finger arm which is rigidly connected to the disc head therefore follows the rotation of the disc head and will erect relative to the shaft lying on the ground or floor, and can therefore be gripped by a person without need to bend down towards the ground or floor.

The auxiliary grip part is preferably made of a lightweight material such as foam, e.g. of expanded polymeric material such as polypropylene (EPP). The auxiliary grip part may favorably be produced as a one-piece part comprising the disc head and the finger arm integrally formed to one another. The auxiliary grip part may be made as a one-piece part from sheet material, e.g. from a sheet of expanded polymer material such as an EPP panel. Alternatively, the auxiliary grip part may be foamed in a negative mold as a molded part from the polymer material. Thus, the auxiliary grip part is stiff and dimensionally stable despite of its cost-effective and light-weight structure and can therefore be easily triggered when it hits the ground, i.e. pivot from an orientation parallel to the shaft into a deflected, upward-pointing orientation. Further advantages of this embodiment include the protection of the floor when the disc head is made of foamed plastic material, and the avoidance of noise.

According to one embodiment of the invention, a locking means for the finger arm is provided on the shaft of the crutch near the foot. When the finger arm snaps into place, it extends along and close to the shaft of the crutch, so that the auxiliary grip part will not interfere during normal handling of the crutch.

According to an advantageous embodiment of the invention, the bearing axis of the auxiliary grip part is implemented as a shaft of a threaded head bolt which has a threaded end portion that engages in a nut attached to the fastening clamp, and which has a head end capturing the disc head. By means of such a threaded head bolt, the auxiliary grip part can be loosely mounted to the shaft of the crutch or, more generally, to a shaft-like object in such a manner that easy swiveling of the grip part is ensured and jamming can be avoided when the finger arm is expected to erect once the crutch or, more generally, the shaft-like object falls over.

In order to further improve the functionality of the crutch and to give the crutch a more elegant appearance, the disc head may comprise a bounce-tilt attachment which covers the otherwise free end of the bearing axis, in particular the head of the screw bolt, the shaft of which is used as the bearing axis. The bounce-tilt attachment may have a plurality of fastening knobs which are useful for engaging in and latching behind bores in the disc head and which allow to conceal the fixation of the bounce-tilt attachment to the disc head.

The locking means arranged near the foot of the crutch may be implemented by a locking plate which has a fitting bore fitted on the shaft of the crutch near the foot thereof and which is provided with a locking recess for receiving the free end of the finger arm of the auxiliary grip part. In this way, the auxiliary grip part is held close to the shaft of the crutch as long as the disc head does not hit the ground when the crutch falls over. The locking means may as well consist of two hook-like locking teeth at the end of the finger arm, which engage loosely on the crutch near the foot and are released when the crutch falls over.

The prior art crutches on the market may be retrofitted in the sense of the invention. For this purpose, a kit is used which comprises the components of the pick-up aid. These components include at least the auxiliary grip part with the disc head and the finger arm, a fastening clamp with a nut attached thereto, and a threaded head bolt for mounting the disc head to the nut of the fastening clamp so that the auxiliary grip part is freely pivotable about the threaded bolt. Moreover, a locking plate is advantageously provided, which has a fitting bore for being fitted on the shaft of the crutch, and which has a locking recess to receive the free end of the finger arm, or else the finger arm has two hook-like locking teeth which define a locking means for the auxiliary grip part in cooperation with a portion of the crutch. The kit may moreover comprise a bounce-tilt attachment which has fastening knobs for engaging in and latching behind bores in the disc head. The bounce-tilt attachment advantageously has a curved or conical outer contour.

Tools defining a shaft-like object and having an upper grip end and a lower working end may also be considered as an application area for the pick-up aid according to the invention. Floor cleaning mops, brooms, rakes, or shovels may be mentioned as examples of such tools. What is referred to as a shaft in a crutch is the handle in such a tool. The lower end of the tools listed above has a width in the horizontal direction which exceeds the dimension in the direction perpendicular thereto. As a result thereof, the tool preferably comes to rest on one of its sides when it falls over. Generally speaking, the shaft-like object has a preferred direction of falling over.

The invention takes advantage of this fact and arranges the pick-up aid on the tool or, more generally, on the shaft-like object in such a way that, when the tool or shaft-like object falls over, the disc head will hit the ground and trigger the auxiliary grip part to erect.

In the case of the mentioned tools, the pick-up aid can be mounted to the handle of the tool using the fastening clamp a described for the case of the crutch. However, it is also possible to use a handle that has a slot for accommodating the pick-up aid therein. The slot extends along an upper portion of the handle of the tool and has a length corresponding to the length of the auxiliary grip part. The bearing axis extends transversely across the slot and supports the auxiliary grip part at or near the grip end of the tool in a pivotable manner.

According to a preferred embodiment of the invention, the disc head of the auxiliary grip part has the shape of a semicircular disc with an eccentric bearing bore and is pivotably mounted in the slot by means of a threaded bolt. Semicircular disc is understood to mean a disc having a circular edge along an angular range covering between 180° and 210°. The disc head furthermore has a straight edge from which the finger arm extends.

The invention will now be explained in more detail by way of exemplary embodiments and with reference to the figures in which the same and similar elements are in part denoted by the same reference numerals and wherein the features of the different exemplary embodiments can be combined with one another.

### BRIEF DESCRIPTION OF THE DRAWINGS

Exemplary embodiments of the invention are described with reference to the drawings, wherein:

FIG. 1 shows a forearm crutch equipped with a pick-up aid in an upright position;

FIG. 2 shows the forearm crutch in a lying position with the pick-up aid triggered;

FIG. 3 shows the pick-up aid as a component before assembly;

FIG. 4 shows a fastening clamp;

FIG. 5 shows a locking plate;

FIG. 6 shows a bounce-tilt attachment in an inverted position;

FIG. 7 is a front view and

FIG. 8 is a side view of an armpit crutch with pick-up aid;

FIG. 9 shows the components of a kit;

FIG. 10 shows a broom or scrubber as seen from the broad side;

FIG. 11 shows the broom or scrubber as seen from the narrow side;

FIG. 12 shows the broom or scrubber lying;

FIG. 13 shows a floor cleaning mop with a cross strut;

FIG. 14 shows a disc head with a smooth circular edge; and

FIG. 15 shows a disc head with a corrugated circular edge.

### DETAILED DESCRIPTION OF THE EXEMPLARY EMBODIMENTS

FIGS. 1 and 2 illustrate a commercially available forearm crutch in the form of a shaft 1 comprising a telescopic rod 10 with an outer tube 11 and an inner tube 12, on which a foot 13 is attached. The forearm crutch furthermore has a grip 14 and a forearm support 15. However, the invention can also be used with an armpit crutch (FIGS. 7 to 9).

Pivotally mounted to the shaft 1 is an auxiliary grip part 2 comprising a disc head 21 and a finger arm 22. The auxiliary grip part 2 may be made as a stamped sheet metal part or may be made of elastic plastics or of in particular solid foam or foam rubber. Elastic plastics such as in particular foamed polymer material with elastomeric properties has the advantage that the auxiliary grip part will trigger well when it hits the ground or floor, and it is durable. Moreover, the floor does not risk to be damaged and unnecessary noise is avoided. Expanded polymer material, especially expanded polypropylene (EPP) has been found to be suitable as a material. The finger arm may have a sliding finish.

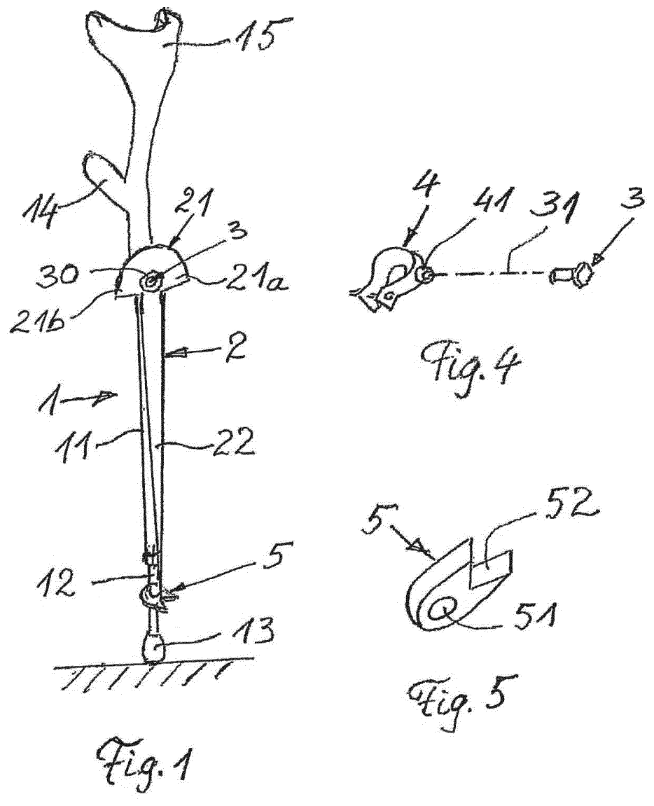

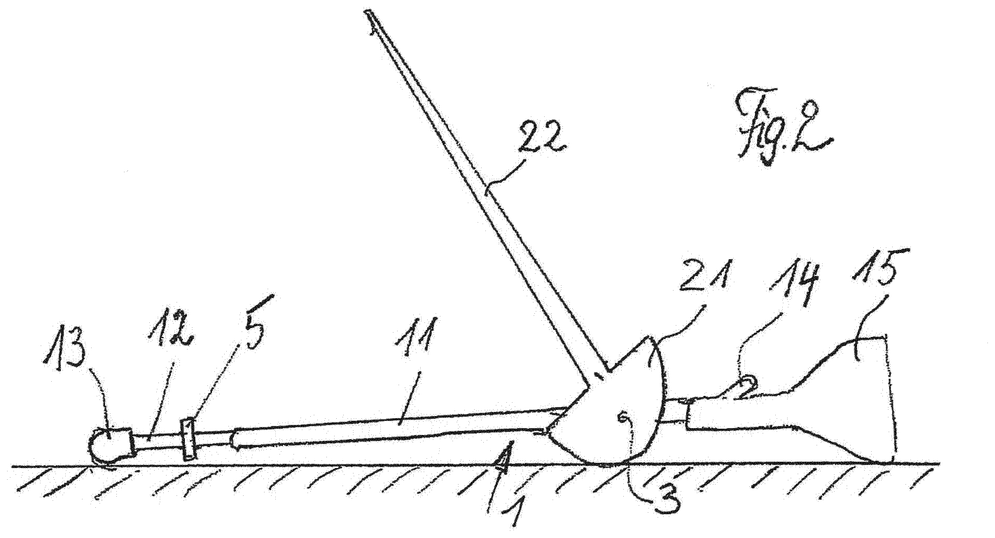

The disc head 21 has a circular edge along an angle range of approximately 200° to 210° and is provided with a bearing bore which is located slightly offset from the center of the circle. More particularly, the disc head 21 is wider than it is high and generates the torque for erecting the auxiliary grip part 2 when the weight of the fallen crutch acts on the disc head 21. The disc head 21 has actuating vertices 21a, 21b which are in particular at a greater distance from the axis of rotation than the central apex of the disc head 21, and which, when hitting the ground, contribute to the fact that the auxiliary grip part becomes unlocked and pivots. For this purpose, the auxiliary grip part 2 is mounted on the shaft 1 by means of a threaded head bolt 3 using the bearing bore and a washer 30. For this purpose, a fastening clamp 4 (FIG. 4) is used on the shaft side, which has a nut 41 attached on the outer surface thereof, soldered or welded thereto. The fastening clamp 4 is fitted around the outer tube 11 at the upper end thereof so that the nut 41 faces the threaded head bolt 3, which is screwed into the nut 41 until engaging the fastening clamp 4. The threaded head bolt 3 has a shaft length which is sufficient to enable the auxiliary grip part 2 to pivot freely about the bolt shaft without jamming. The threaded head bolt 3 with its shaft defining the bearing axis 31 extends substantially parallel to the longitudinal extension of grip 14, so that the pivoting plane of the disc head 21 extends approximately perpendicular to the plane which is defined by the longitudinal extension of grip 14, telescopic rod 10, and the shaft of threaded head bolt 3. ‘Approximately’ or ‘substantially’ means that deviations from the plane defined by the grip and the telescopic rod are allowed as long as the pivoting of the auxiliary grip part 2 is not impaired when the crutch falls down.

In order to prevent the auxiliary grip part 2 from swiveling when walking with the crutch, a locking means is provided near the foot 13, which locks the lower end of the finger arm 22 and automatically releases or unlocks when the crutch falls down, due to the shock of the impact. The unlocking may be promoted by making the auxiliary grip part 2 from an elastic, optionally foamed plastic material, e.g. an optionally foamed elastomer. In the illustrated exemplary embodiment, the locking means comprises a locking plate 5 (FIG. 5) which has a fitting hole 51 for being fitted on the inner tube 12 of the telescopic rod 10 and a locking recess 52 in which the free lower end of the finger arm 22 is received.

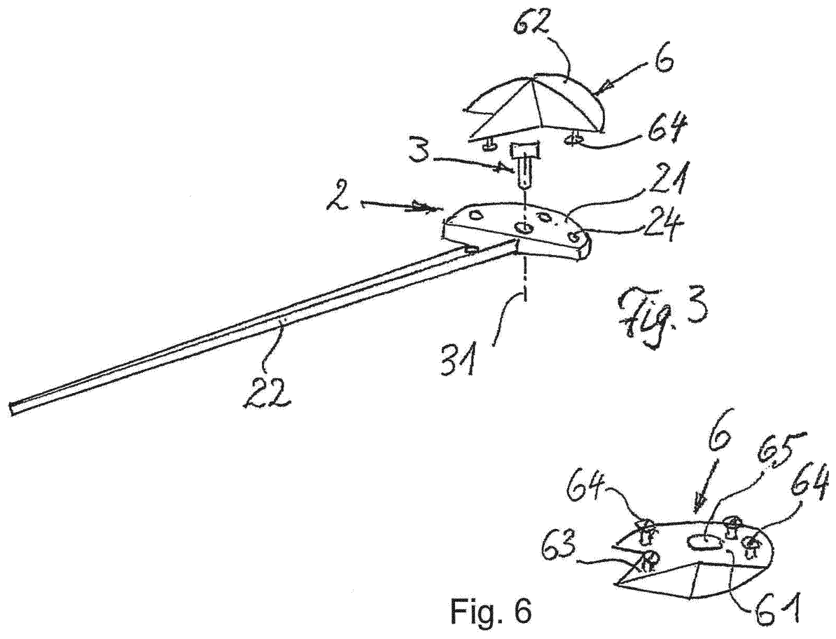

For the purpose of improving the toppling behavior of the device and the aesthetic design, the head of the threaded head bolt 3 may be covered, and for this purpose a bounce-tilt attachment 6 (FIGS. 3, 6, and 9) is used, which has a semicircular base 61 and a half spherical cap as a curved outer contour 62. Furthermore, adjoining the semicircle of the base, there is a triangular surface 63 which partially covers the finger arm 22. In the present case, four fastening knobs 64 are provided on the base 61 including the triangular surface 63, furthermore a recess 65 is provided for accommodating the head of the threaded head bolt 3 and the washer 30. The disc head 21 has a series of bores 24 matching the fastening knobs 64 and through which the fastening knobs 64 can engage to cause the fixing of the bounce-tilt attachment on the disc head 21 by engaging therein.

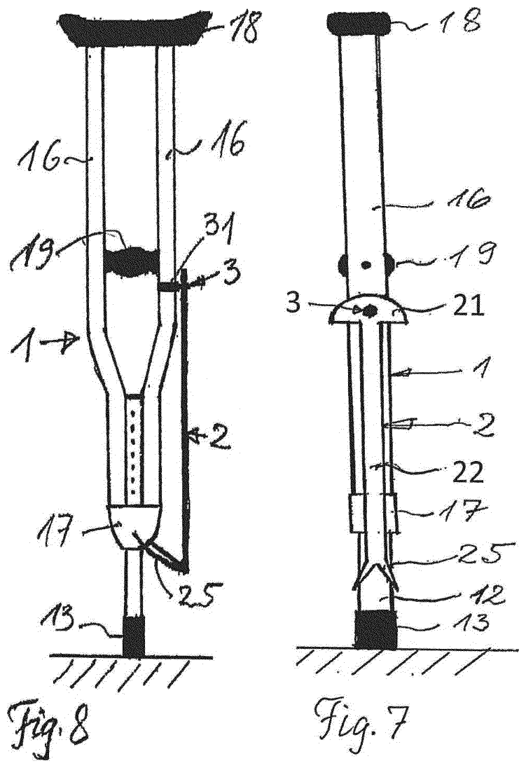

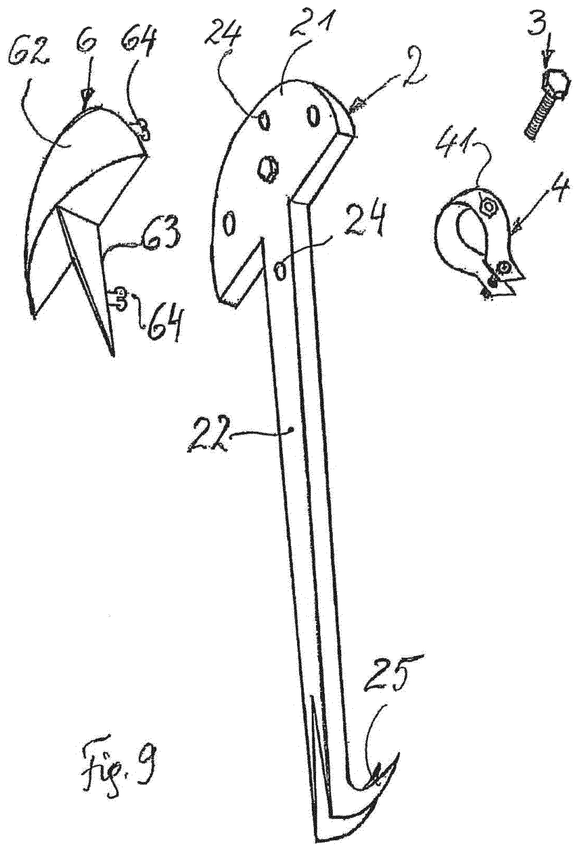

FIG. 7 shows a front view of an armpit crutch with pick-up aid in an upright position. Components similar to those of the crutch of FIG. 1 are denoted by the same reference numerals. However, locking plate 5 is eliminated here. Instead, an auxiliary grip part 2 is used, which has hook-like locking teeth as shown in FIGS. 8 and 9. However, it goes without saying that this auxiliary grip part 2 may as well be used in the forearm crutch of FIGS. 1 and 2, just as the auxiliary grip part 2 according to FIG. 3 in combination with the locking plate of FIG. 5 may be used in the armpit crutch of FIGS. 7 and 8. Thus, more generally, the auxiliary grip part 2 is locked at the lower end of the crutch, and the locking is automatically released when the crutch falls down and the disc head 21 hits the ground.

In the case of an armpit crutch, the shaft 1 is formed with two arms or legs 16, which extend parallel to one another in sections thereof and are connected to one another at the lower end by means of a connecting piece 17, at the upper end by an armpit support 18 and in the central region by a grip 19, as known per se. The auxiliary grip part 2 is pivotally mounted on an arm or leg 16 of the armpit crutch by means of the threaded head bolt 3. The lower end of auxiliary grip part 2 is bifurcated and has two hook-like locking teeth 25 which, during normal use of the armpit crutch, are engaged and retained below the connecting piece 17 and on the curved underside thereof, similar to the case of the locking device according to FIGS. 1 to 6.

To improve the functionality of the device, the bounce-tilt attachment 6 may be fitted onto the disc head 21, as described in the first exemplary embodiment.

A kit for complementing the armpit crutch is shown in FIG. 9. The components are assembled as described in the first exemplary embodiment.

The crutch with pick-up aid functions as follows:

When not in use, crutches are usually leaned against a wall, with the grip 14 and forearm support 15 or the armpit support 18 leaning against the wall, while the foot 13 is supported on the floor. If the crutch falls over due to a lateral impact, the disc head 21, directed by the grip and optionally the forearm support or armpit support, hits the floor with one of the actuating vertices 21a, 21b and causes a torque around the shaft of the threaded head bolt 3 defining the pivot axis 31. The impact and the torque are strong enough to release the finger arm 22 out of its locked position. As a result, the finger arm 22 will erect at an angle (FIG. 2) and may optionally assume an orientation of up to 90° relative to the extension of the shaft, so that the finger arm can be comfortably gripped by the user of the crutch. This permits to pick up the crutch without having to bend down towards the floor or ground.

The bounce-tilt attachment 6 prevents the crutch from coming to rest with the auxiliary grip part 2 lying on the ground after falling over, that means the crutch will always take a position in which the finger arm 22 can raise without dragging on the ground. As mentioned before, the bounce-tilt attachment transfers the force of the falling crutch into a torque of the finger arm 22 about the pivot axis 31 (while protecting the head of the screw bolt 3).

If the finger arm 22 is not upright enough after the crutch has fallen over, a kick of the user's foot to the rubber foot 13 will be sufficient to further erect the finger arm 22.

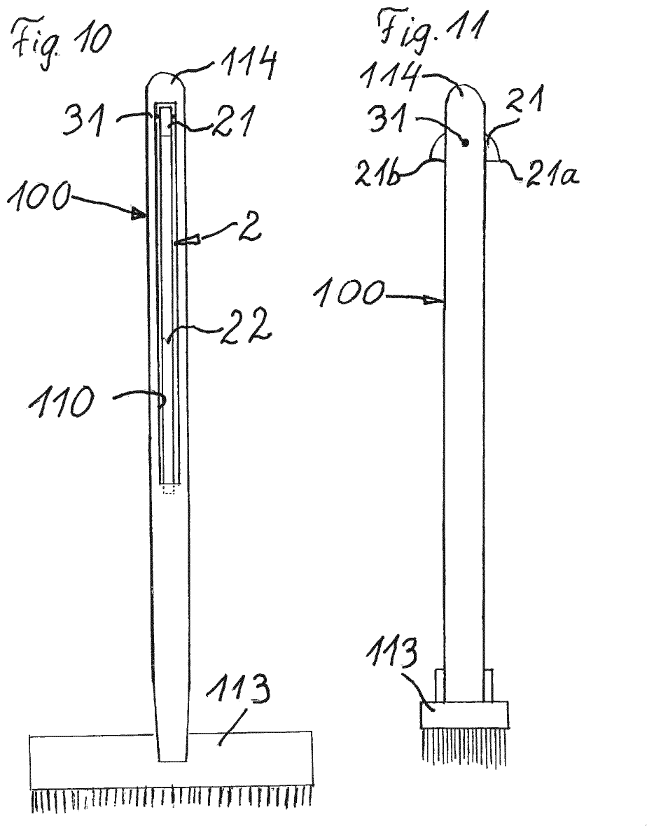

FIGS. 10 to 15 show further embodiments of the attachment of a pick-up aid to a shaft-like object. Here, a broom or scrubber (FIGS. 10 to 12) and a floor cleaning mop (FIG. 13) are shown, all of which are working tools which define a shaft-like object with an upper grip end 114 and a lower working end 113. The working end on the floor has a width dimension in the horizontal direction, which exceeds by far the dimension perpendicular thereto on the floor. If such a tool falls over to the floor, it will always tilt about its width extent on the lower end. In other words, the tool is overall shaped so that it preferably will impact with one of its sides when it falls over. So, the tool has a preferred direction of falling over. This fact is exploited in the invention by having the disc head 21 of the auxiliary grip part 2 of the pick-up aid arranged in the vicinity of the upper grip end 114 on that side of the tool on which the tool comes to rest when it falls over.

FIGS. 10 to 12 show a broom or scrubber with integrated pick-up aid. The handle 100 of the tool has a slot 110 which extends along an upper portion of the handle 100 over a length that corresponds to the length of the auxiliary grip part 2. If the finger arm 22 of the auxiliary grip part 2 is provided with hook-like locking teeth 25 according to FIGS. 7 and 8, then these locking teeth will engage on the lower end of the slot 110 with slight pressure and retain the auxiliary grip part 2 within the slot 110.

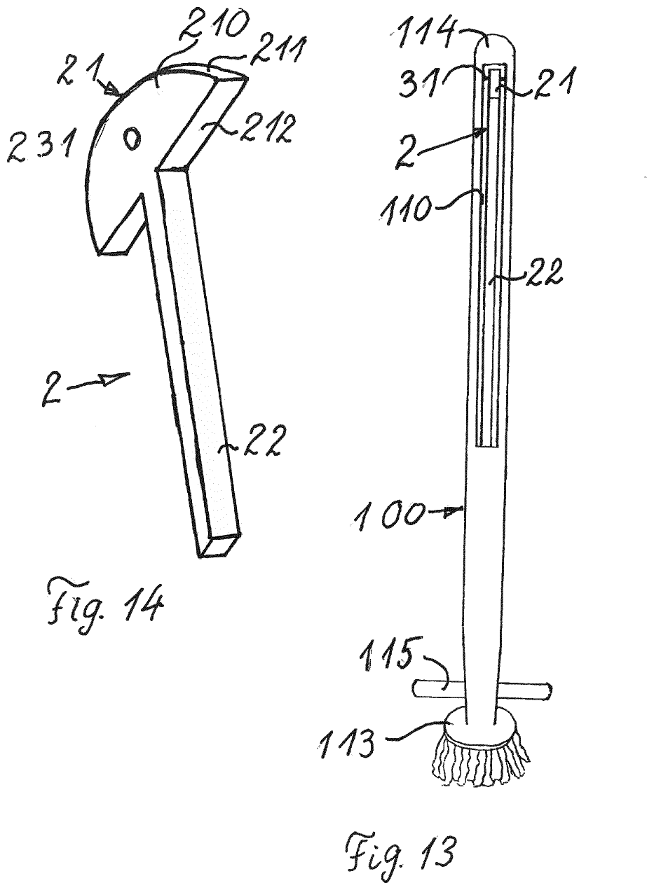

The disc head 21 of the auxiliary grip part 2 has the shape of a semicircular disc 210 with an eccentric bearing bore 231, as best seen in FIGS. 14 and 15. The semicircular disc 210 has a circular edge 211, and a straight edge 212 from which the finger arm 22 extends. The circular edge 211 may be a smooth edge (FIG. 14) or may be corrugated (FIG. 15). Bearing bore 231 is provided eccentrically to the semicircular disc 210, i.e. at a certain distance from the center of curvature of the circular edge 211. Bearing axis 31 extends transversely across the slot 110 and the bearing bore 231 and supports the auxiliary grip part 2 at or near the grip end 114 of the tool, so that the auxiliary grip part 2, when triggered, can pivot from its initial position to the deflected upward-pointing position. In the simplest way, the bearing axis 31 is implemented by the shaft of a threaded bolt, which extends transversely to the handle 100 and across the slot 110 and through the bearing bore 231. This type of mounting is well known to a person skilled in the art and therefore does not need to be illustrated in the drawing.

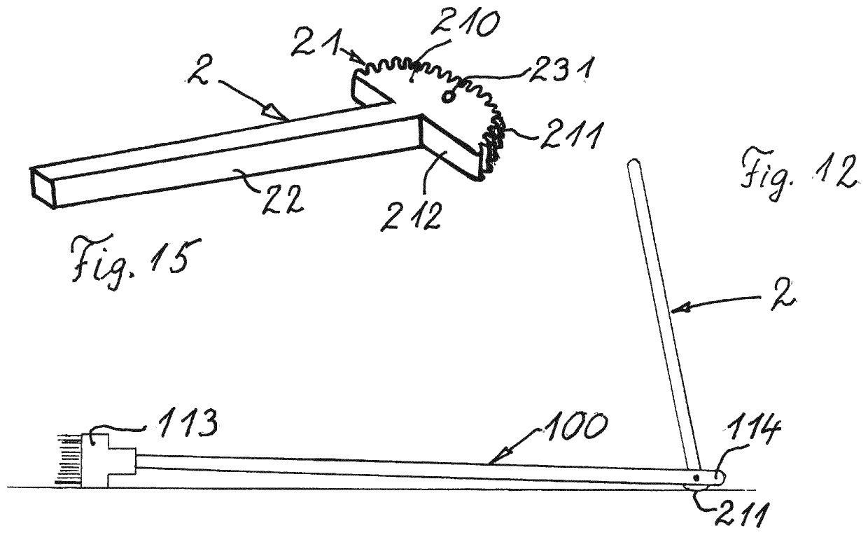

FIG. 12 shows the broom or scrubber with the pick-up aid in the triggered and released position of the auxiliary grip part 2. This position is achieved due to the fact that the broom or scrubber, when falling over, will hit the ground with the disc head 21 of its pick-up aid thereby exerting a force on one of the actuating vertices 21a, 21b (FIG. 11) thereof, as has been described above with reference to FIG. 1. Should the auxiliary grip part 2 not have been fully erected, a small foot kick can be given to the lower working end 113 of the broom or scrubber towards the handle 100, whereby the circular edge 211 of the disc head 21 will roll over the ground or floor and the auxiliary grip part 2 will erect further. The corrugated shape of the circular edge 211 (FIG. 15) is advantageous for this rolling effect.

FIG. 13 shows a floor cleaning mop having a disc-shaped circular working end 113. Such a tool does not have a preferred direction of falling over per se. In order to obtain a preferred direction of falling over, the handle 100 of the floor cleaning mop has a cross strut 115 which extends parallel to the bearing axis 31 and is arranged in the vicinity of the working end of the tool. If the tool falls over in the wrong direction, the cross strut 115 will direct the tool to the correct fall direction so that it will impact on the floor with the disc head 21 and trigger the erection of the auxiliary grip part 2.

The tool may as well be equipped with a pick-up aid of the type of FIGS. 1 through 9. For this purpose, the auxiliary grip part 2 is mounted to the handle of the tool by means of a fastening clamp 4 which has a nut 41 attached thereto, which cooperates with a threaded head bolt 3 that defines the bearing axis 31 of the auxiliary grip part 2. In such a case, the handle of the tool will not have a slot, i.e. will have a configuration as conventionally available. The pick-up aid can also be retrofitted to the tool, and the kit according to FIG. 9 will be useful for this purpose.

In summary, the pick-up aid according to the invention is mounted on a shaft-like object which may be a crutch or a tool. The pick-up aid is mounted on the shaft 1 of the crutch or on the handle 100 of the tool so as to be pivotable about a bearing axis 31 and comprises an auxiliary grip part 2 having a disc head 21 and a finger arm 22 which extends along the shaft 1 or handle 100 in an initial position during intended use of the shaft-like object. The shaft-like object inherently has a preferred direction of falling over or is adapted such that a preferred direction of falling over is caused. The pick-up aid is mounted on the shaft-like object in such a manner that when the latter falls over it will impact with the disc head 21, whereby the finger arm 22 will erect from its initial position relative to the shaft 1 or handle 100 and can be easily gripped in order to lift the shaft-like object from the ground or floor without having to bend down completely.

It will be apparent to a person skilled in the art that the embodiments described above are meant to be exemplary and that the invention is not limited thereto but may be varied in many ways without departing from the scope of the claims. Furthermore, it will be apparent that irrespective of whether disclosed in the description, the claims, the figures, or otherwise, the features individually define essential components of the invention, even if they are described together with other features.

1. A pick-up aid on a shaft-like object which has a shaft or handle and tends to fall over to a preferred direction, comprising:
an auxiliary grip part comprising a disc head and a finger arm;
a bearing axis pivotally supporting the auxiliary grip part on the shaft or handle and oriented transversely to the longitudinal extension of the shaft or handle;
wherein during intended use of the shaft-like object, the finger arm of the auxiliary grip part extends along the shaft or handle of the shaft-like object;
however, when the shaft-like object falls over and the disc head hits the ground, the finger arm is erected and can be easily gripped.

2. The pick-up aid of claim 1,
wherein the shaft-like object is in the form of a crutch which comprises the shaft and a grip spanning a plane in which the bearing axis extends perpendicular to the shaft, supporting the disc head which is pivotable in a plane perpendicular to the bearing axis.

3. The pick-up aid of claim 2,
wherein the crutch has a foot and wherein a locking means for the finger arm is effective on the shaft near the foot.

4. The pick-up aid as claimed in claim 2,
wherein the crutch comprises a fastening clamp which supports the bearing axis for the disc head.

5. The pick-up aid of claim 4,
wherein the bearing axis is in the form of a shaft of a threaded head bolt having a threaded end portion that engages in a nut attached to the fastening clamp, and having a head end capturing the disc head.

6. The pick-up aid as claimed in claim 1,
wherein the disc head comprises a bounce-tilt attachment.

7. The pick-up aid of claim 6,
wherein the bounce-tilt attachment has a plurality of fastening knobs for engaging in and latching behind bores in the disc head.

8. The pick-up aid as claimed in claim 3,
wherein the locking means comprises a locking plate which has a fitting bore for being fitted on the shaft near the foot, and a locking recess for receiving the free end of the finger arm.

9. The pick-up aid as claimed in claim 3,
wherein the locking means comprises two locking teeth at the free end of the finger arm.

10. A kit for complementing or retrofitting a shaft-like object with a pick-up aid according to claim 1, comprising:
an auxiliary grip part comprising a disc head and a finger arm;
a fastening clamp adapted for being attached to the shaft-like object; and
fastening means for mounting the disc head to the shaft-like object for free rotation of the auxiliary grip part.

11. The kit of claim 10,
wherein the fastening means comprise a threaded head bolt and a nut attached to the fastening clamp, wherein the auxiliary grip part can be mounted to the nut of the fastening clamp by means of the threaded head bolt for free rotation about the shaft of the threaded head bolt.

12. The kit of claim 10, comprising:
means for releasably locking the auxiliary grip part at a lower end of the shaft-like object, in particular in the form of a locking plate which has a fitting bore for being fitted on the shaft or handle of the shaft-like object, and a locking recess appropriate for receiving the free end of the finger arm; or in the form of locking teeth on the free end of the finger arm.

13. The kit as claimed in claim 10, further comprising:
a bounce-tilt attachment having a curved or conical outer contour.

14. The kit of claim 13, wherein the bounce-tilt attachment has fastening knobs for engaging in and latching behind bores in the disc head.

15. The kit of claim 14,
wherein the bounce-tilt attachment has a semicircular base with an adjoining triangular surface, on which the fastening knobs are provided.

16. The pick-up aid of claim 1,
wherein the shaft-like object is in the form of a tool having an upper grip end and a lower working end and tends to fall over to a preferred direction;
wherein the handle of the tool has a slot which extends along an upper portion of the handle and has a length corresponding to the length of the auxiliary grip part; and
wherein the bearing axis extends transversely across the slot and the auxiliary grip part is pivotably mounted at or near the grip end of the tool.

17. The pick-up aid of claim 16,
wherein the disc head of the auxiliary grip part has a shape of a semicircular disc with an eccentric bearing bore and is pivotably mounted in the slot by means of a threaded bolt.

18. The pick-up aid of claim 17,
wherein the semicircular disc has a circular edge, and a straight edge from which the finger arm extends.

19. The pick-up aid according to claim 16,
wherein the lower working end of the tool has a width dimension parallel to the bearing axis which is greater than the dimension of the working end perpendicular to the width dimension; or,
if the width dimension of the working end is approximately equal to the dimension perpendicular thereto, then the handle has a cross strut that extends parallel to the bearing axis.

20. The pick-up aid of claim 1,
wherein the shaft-like object is in the form of a tool having an upper grip end and a lower working end and tends to fall over to a preferred direction;
wherein furthermore the auxiliary grip part is mounted to the handle of the tool by means of a fastening clamp which has a nut attached thereto, which cooperates with a threaded head bolt that defines the bearing axis of the auxiliary grip part.

21. A crutch in the form of a shaft, in particular having a forearm support or armpit support at a first end and a foot at the second end; comprising a pick-up aid which comprises an auxiliary grip part which is pivotable about a bearing axis that is oriented transversely to the shaft of the crutch, and which comprises a disc head and a finger arm, which, when the crutch falls over and the disc head of the crutch hits the ground, can pivot from an orientation parallel to the shaft to a deflected, upward-pointing orientation.

22. The crutch of claim 21,
comprising a grip, wherein the bearing axis, the shaft and the grip are arranged in a plane or substantially in a plane, and wherein the bearing axis extends parallel or substantially parallel to the longitudinal extension of the grip.

23. The crutch of claim 21,
wherein a locking means for the finger arm is effective on the shaft near the foot.

24. The crutch according to claim 21,
comprising a fastening clamp which supports the bearing axis for the disc head.

25. The crutch of claim 24,
wherein the bearing axis is defined by a shaft of a threaded head bolt having a threaded end portion that engages in a nut attached to the fastening clamp, and having a head end capturing the disc head.

26. The crutch according to claim 21,
wherein the disc head comprises a bounce-tilt attachment.

27. The crutch of claim 26
wherein the bounce-tilt attachment has a plurality of fastening knobs for engaging in and latching behind bores in the disc head.

28. The crutch according to claim 23,
wherein the locking means comprises a locking plate which has a fitting bore for being fitted on the shaft near the foot and a locking recess for receiving the free end of the finger arm.

29. The crutch according to claim 23,
wherein the locking means comprises two locking teeth at the free end of the finger arm.

30. A kit for complementing or retrofitting a crutch with a pick-up aid, comprising:
an auxiliary grip part comprising a disc head and a finger arm;
a fastening clamp adapted for being attached to the shaft of a crutch; and
fastening means for mounting the disc head to the crutch for free rotation of the auxiliary grip part.

31. The kit of claim 30,
wherein the fastening means comprise a threaded head bolt and a nut attached to the fastening clamp, wherein the auxiliary grip part can be mounted to the nut of the fastening clamp by means of the threaded head bolt for free rotation about the shaft of the threaded head bolt.

32. The kit of claim 30, comprising:
means for releasably locking the auxiliary grip part at a lower end of the crutch, in particular in the form of a locking plate which has a fitting bore for being fitted on the shaft of the crutch, and a locking recess appropriate for receiving the free end of the finger arm; or in the form of locking teeth on the free end of the finger arm.

33. The kit according to claim 30, further comprising:
a bounce-tilt attachment which has a curved or conical outer contour.

34. The kit of claim 33, wherein the bounce-tilt attachment has fastening knobs for engaging in and latching behind bores in the disc head.

35. The kit of claim 34,
wherein the bounce-tilt attachment has a semicircular base with an adjoining triangular surface, on which the fastening knobs are provided.
